(19) United States
(12) Patent Application Publication
(10) Pub. No.: US 2024/0403414 A1
(43) Pub. Date: Dec. 5, 2024

(54) NETWORK PROTECTION

(71) Applicant: BRITISH TELECOMMUNICATIONS PUBLIC LIMITED COMPANY, LONDON (GB)

(72) Inventor: Sadiq SANI, London (GB)

(21) Appl. No.: 18/691,327

(22) PCT Filed: Sep. 5, 2022
(86) PCT No.: PCT/EP2022/074630

§ 371 Date: Mar. 12, 2024

(30) Foreign Application Priority Data
Sep. 15, 2021 (GB) 2113173.5

(51) Int. Cl. G06F 21/55

(52) U.S. Cl. CPC G06F 21/55

(57) ABSTRACT

A computer implemented method, computer system and computer program for protecting a network are provided. The method trains a classifier to classify activity within the network. The method retrains the classifier using an active learning technique by: determining a respective level of uncertainty of the classifier in classifying each sample in a set of sample data; identifying a subset of the sample data, the subset including a plurality of samples from the set for which the respective level of uncertainty is highest; randomly selecting a number of samples from the subset, wherein the number of samples is less than a size of the subset; labelling the selected samples by querying an oracle; and using training data including the labelled samples to retrain the classifier. The method uses the retrained classifier to classify activity within the network and determines whether to take action to protect the network based on the classification of the activity.

### PRIORITY CLAIM

The present application is a National Phase entry of PCT Application No. PCT/EP2022/074630, filed Sep. 5, 2022, which claims priority from GB Application No. 2113173.5, filed Sep. 15, 2021, each of which hereby fully incorporated herein by reference.

### TECHNICAL FIELD

The present disclosure relates to protecting a network. In particular, the present disclosure relates to the training of a classifier using an active learning technique and the use of the classifier to determine whether to take action to protect the network.

### BACKGROUND

As the number of threats to networks increases, network operators are increasingly turning to the use of machine learning to train classifiers which can be used to distinguish genuine legitimate activity in the network from malicious activity that is associated with a threat to the network. Such classifiers may be incorporated in so-called intrusion detection systems (IDS) to alert network administrators of threats to a network (or to computer systems within the network). In some cases, such systems may also automatically take action to prevent or mitigate the threat that has been detected. These systems are commonly referred to as intrusion prevention systems (IPSs).

Active learning is a machine learning technique which may be used to train a classifier. The goal of active learning is to reduce the amount of labelling which needs to be performed to train a classifier. This is advantageous because labelling sample data to create a dataset upon which to train a classifier can be expensive and time consuming. Meanwhile, in certain situations, it can be relatively easy to obtain a large quantity of unlabeled sample data.

Under the active learning approach, the data that is used to train the classifier (also referred to as training data) is only partially labelled. That is to say, only some of the samples in the training data are labelled (i.e. associated with a known classification) whilst the remaining samples are unlabeled (i.e. a correct classification for those samples is not known). An iterative training process is then undertaken. In a first iteration, the classifier is trained using just those samples in the training data that were labelled at the outset. In each subsequent iteration a number of unlabeled samples are labelled via consultation with a so-called oracle (or teacher), thereby increasing the number of labelled samples in the training data. The oracle may be a human or an automated system that is capable of in-depth analysis of a sample to determine its correct classification (i.e. label). The classifier is then re-trained using all of the available labelled samples in the training data (i.e. the samples that were already labelled in the initial training data, as well as any data that has been labelled by the oracle during the current or previous iterations of training). Following this approach, it is generally expected that a classifier can be trained having a particular level of performance (e.g. its classification accuracy) without needing to label all of the samples in the training data.

The question of how to select the samples that are labelled between each iteration of training is an area active research in the field of active learning. This is because not all of the unlabeled samples are of equal value when it comes to helping train the classifier. That is to say, the selection of certain samples for labelling may help the classifier reach a better level of performance than the selection of other samples. Therefore, the selection of the unlabeled samples to be labelled by the oracle between each iteration can impact the speed at which the classifier is trained and, as a result, the overall number of samples that need labelling to train the classifier to a particular level of performance.

One approach that has been traditionally used to select which samples should be labelled between iterations of learning utilizes the uncertainty of the classifier in its predicted classification for each sample. Under this approach, the unlabeled samples are ranked according the classifier's uncertainty in classifying each sample and the sample about which the classifier is most uncertain is selected to be labelled by the oracle. The newly labelled sample is then added to the training data and used to retrain the classifier before repeating the process.

A drawback to this approach is that it can prove to be inefficient when it takes a long time (e.g. several hours or even days) to retrain a classifier. In such cases, if only a single sample is selected for labelling between each iteration of training, the amount of time required to train a classifier to a suitable level of performance (which may require thousands of samples to be labelled by the oracle) can prove to be impractical.

To address this issue, this approach has been extended to provide a batch-mode version in which multiple samples are selected for labelling between each iteration. Specifically, a batch-size is selected and, between iterations of training, a number of samples corresponding to the batch size are selected for labelling. Again, the samples that are selected are those that the classifier is most uncertain about (e.g. for a batch size of 50, the top 50 samples in the list of samples ranked according to uncertainty would be selected).

### SUMMARY

Under the above-described batch-mode approach to active learning, there tends to be a certain amount of overlap in the information gained by labelling those samples. This is because multiple samples are likely to be clustered around the same areas of uncertainty in the classifier. Therefore, the same (or similar) improvement in performance that is provided by labelling a large number of samples in a particular cluster could be delivered by fewer (e.g. one or two) samples in that same cluster.

Furthermore, it is likely that, by including more samples around a particular area of uncertainty in the classifier, other areas of uncertainty (which are nonetheless areas that it would be desirable for the classifier to improve on) are likely to be excluded (that is to say that no samples relating to those areas are likely to be sent to the oracle for labelling in that iteration of training). As a result, such approaches can take longer to train a classifier and can also require many more samples to be labelled than might otherwise be needed.

One possible solution to this issue is presented in the paper “Batch Mode Active Learning and its Application to Medical Image Classification” by Hoi et al which proposes identifying an optimal set (or batch) of samples for labelling which results in the largest reduction in Fisher information. As will be appreciated by the skilled person, the Fisher information matrix measures the overall information provided by the set of unlabeled examples, meaning that the task is to choose the set of samples that minimizes the ratio between the Fisher information matrix of the entire set of unlabeled samples to that of the set of samples that are selected for labelling. However, this approach is computationally intensive, which may be undesirable, especially when it is required to be performed with each iteration of training.

Accordingly, it would be beneficial to mitigate these disadvantages.

The present disclosure accordingly provides, in a first aspect, a computer implemented method for protecting a network, the method comprising: training a classifier to classify activity within the network; retraining the classifier using an active learning technique by: determining a respective level of uncertainty of the classifier in classifying each sample in a set of sample data; identifying a subset of the sample data, the subset comprising a plurality of samples from the set for which the respective level of uncertainty is highest; randomly selecting a number of samples from the subset, wherein the number of samples is less than a size of the subset; labelling the selected samples by querying an oracle; and using training data comprising the labelled samples to retrain the classifier; using the retrained classifier to classify activity within the network; and determining whether to take action to protect the network based on the classification of the activity.

The number of samples that are selected from the subset may be a predetermined number or a predetermined proportion of the subset.

The method may further comprise causing action to be taken to mitigate or prevent the threat from impacting the network in response to determining that action should be taken to protect the network.

One or more classifications provided by the classifier may indicate that the activity is associated with malware and the action may comprise one or more predetermined actions for mitigating or preventing the activity of the malware, the action being taken in response to a classification indicating that the activity is associated with malware.

The classifier may be trained to classify domain names, whereby one or more classifications provided by the classifier indicating that a domain name was generated by a Domain Generation Algorithm, DGA, used to generate domain names for malware. The activity may comprise a DNS query made by a computer system in the network. The one or more predetermined actions may be taken in response to a classification of a domain name that is a subject of the DNS query indicating that the domain name was generated by a DGA used to generate domain names for malware. The one or more predetermined actions may comprise one or more, or all, of: causing a malware scan to be performed in respect of the computer system; increasing a level of monitoring that is performed in respect of the computer system; preventing communication with the domain name; flagging the domain name for review; and logging the access to the domain name.

The present disclosure accordingly provides, in a second aspect, a computer system comprising a processor and a memory storing computer program code for performing the method set out above.

The present disclosure accordingly provides, in a third aspect, a computer program which, when executed by one or more processors, is arranged to carry out the method set out above.

### BRIEF DESCRIPTION OF THE FIGURES

Embodiments of the present disclosure will now be described by way of example only, with reference to the accompanying drawings, in which:

FIG. 1 is a block diagram of a computer system suitable for the operation of embodiments of the present disclosure.

FIG. 2 is a flowchart illustrating a method for protecting against malware according to embodiments of the disclosure.

FIG. 3 is a flowchart illustrating a method for retraining a classifier using active learning that is performed as part of the method illustrated by FIG. 2.

FIG. 4 is a chart showing the results of an evaluation of the performance provided by an embodiment of the disclosure.

### DETAILED DESCRIPTION OF EMBODIMENTS

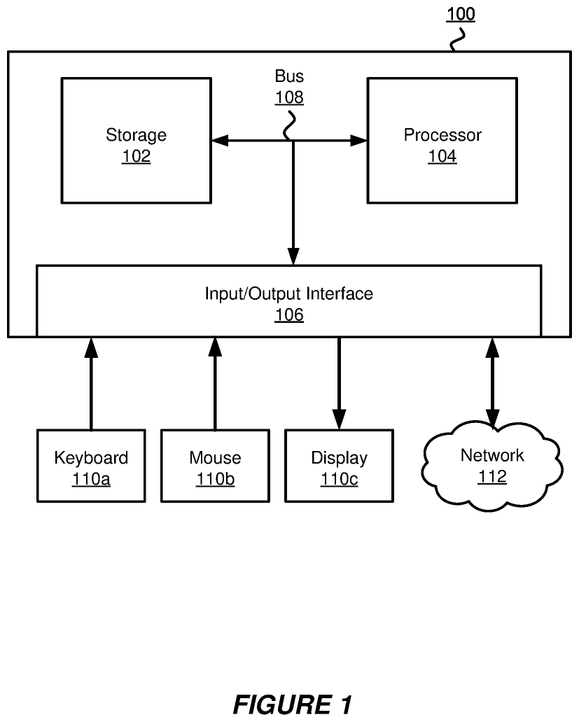

FIG. 1 is a block diagram of a computer system 100 suitable for the operation of embodiments of the present disclosure. The system 100 comprises: a storage 102, a processor 104 and an input/output (I/O) interface 106, which are all communicatively linked over one or more communication buses 108.

The storage (or storage medium or memory) 102 can be any volatile read/write storage device such as a random access memory (RAM) or a non-volatile storage device such as a hard disk drive, magnetic disc, optical disc, ROM and so on. The storage 102 can be formed as a hierarchy of a plurality of different storage devices, including both volatile and non-volatile storage devices, with the different storage devices in the hierarchy providing differing capacities and response times, as is well known in the art.

The processor 104 may be any processing unit, such as a central processing unit (CPU), which is suitable for executing one or more computer programs (or software or instructions or code). These computer programs may be stored in the storage 102. During operation of the system, the computer programs may be provided from the storage 102 to the processor 104 via the one or more buses 108 for execution. One or more of the stored computer programs, when executed by the processor 104, cause the processor 104 to carry out a method according to an embodiment of the disclosure, as discussed below (and accordingly configure the system 100 to be a system 100 according to an embodiment of the disclosure).

The input/output (I/O) interface 106 provides interfaces to devices 110 for the input or output of data, or for both the input and output of data. The devices 110 may include user input interfaces, such as a keyboard 110a or mouse 110b as well as user output interfaces such as a display 110c. Other devices, such a touch screen monitor (not shown) may provide means for both inputting and outputting data. The input/output (I/O) interface 106 may additionally or alternatively enable the computer system 100 to communicate with other computer systems via one or more networks 112. It will be appreciated that there are many different types of I/O interface that may be used with computer system 100 and that, in some cases, computer system 100 may include more than one I/O interface. Furthermore, there are many different types of device 100 that may be used with computer system 100. The devices 110 that interface with the computer system 100 may vary considerably depending on the nature of the computer system 100 and may include devices not explicitly mentioned above, as would be apparent to the skilled person. For example, in some cases, computer system 100 may be a server without any connected user input/output devices. Such a server may receive data via a network 112, carry out processing according to the received data and provide the results of the processing via a network 112.

It will be appreciated that the architecture of the system 100 illustrated in FIG. 1 and described above is merely exemplary and that other computer systems 100 with different architectures (such as those having fewer components, additional components and/or alternative components to those shown in FIG. 1) may be used in embodiments of the disclosure. As examples, the computer system 100 could comprise one or more of: a personal computer; a laptop; a tablet; a mobile telephone (or smartphone); a television set (or set top box); a games console; an augmented/virtual reality headset; a server; or indeed any other computing device with sufficient computing resources to carry out a method according to embodiments of this disclosure.

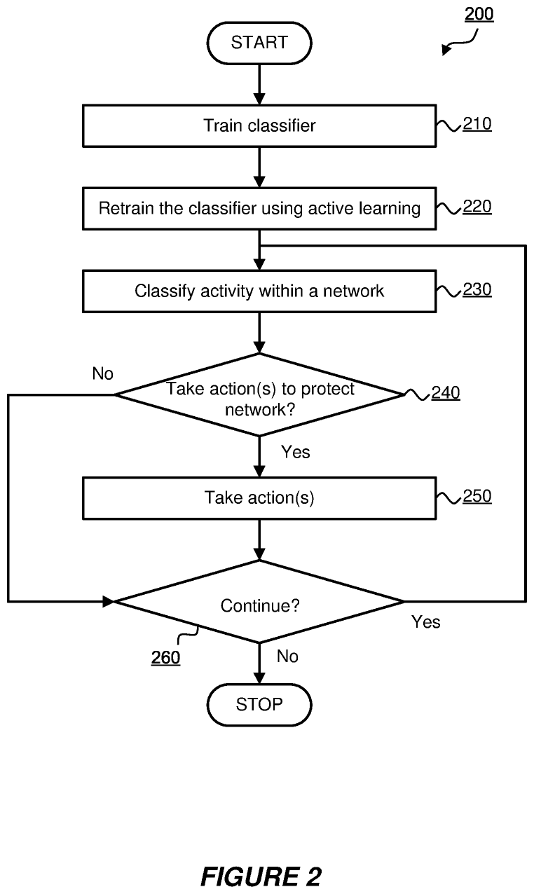

FIG. 2 is a flowchart illustrating a method 200 for protecting a network according to embodiments of the disclosure, such as may be performed by computer system 100.

At an operation 210, the method 200 trains a classifier to classify activity within the network. Specifically, the classifier is trained to provide a classification to indicate whether or not the activity is related to a threat to the network. That is to say, the classifier is trained to classify an activity as belonging to one of a plurality of classifications, whereby at least one classification indicates that the activity is a threat to the network. The classifier can therefore be used to determine whether an activity is legitimate (i.e. relating to genuine activity performed by authorized users or systems) or illegitimate (i.e. relating to malicious activity performed by unauthorized persons or compromised systems). As a result, the classifier can be used to protect the network by taking action to prevent or mitigate any illegitimate activities, as will be discussed in more detail below.

As will be appreciated, there are a wide range of different types of activities (and a wide range of types of threats) that a classifier can be trained to classify in order to produce a classifier that can be used to detect threats to a network. The activity may be an activity that could be associated with malware (but could also be the result of legitimate behavior). Accordingly, one or more classifications provided by the classifier may indicate that the activity is associated with malware. However, the activity may also relate to other malicious sources, such as human-originated hacking attempts, and, in such cases, one or more classifications provided by the classifier may indicate that the activity is associated with a non-malware threat.

Malware (or malicious software) is software which is designed to negatively impact a computer system or network. Once successfully infiltrated into a computer system or network, there are a wide range of functions that malware may carry out in order to achieve the aims of the attacker that deployed the malware. These functions may include functions such as, modifying the systems behavior, monitoring a user's behavior and exfiltration of sensitive data, and carrying out denial-of-service attacks (including, for example, ransomware attacks which encrypt a user's data and demand a payment in return for the encryption). Of course, there are many other functions that malware may carry out on behalf of an attacker, as will be appreciated by the skilled person. As a result, there are large range of activities that occur within a network which might be attributable to malware, which the classifier could be trained to classify in order to detect the malware.

As an example, modern malware is typically designed to provide an attacker with ongoing control over the malware's activities thereby allowing the attacker to change the malware's operation to suit their changing aims (for example, by instructing it to carry out a distributed denial of service (DDOS) attack on a particular computer system or network). In order to achieve this the malware needs to contact a so-called command and control (or C&C) server to receive the attacker's instructions. Historically, an address for the command and control server was fixed and hard-coded into the malware. However, the use of a fixed location for the command and control server provided security researchers and law-enforcement with a way of interrupting the malware's operation-specifically by identifying the location of the command and control server and taking it down (or otherwise preventing communication with that location). This would prevent any new instructions being provided to the malware. Accordingly, in an effort to prevent this, malware authors have increasingly turned to using domain generating algorithms (DGAs) to specify locations at which a malware can contact its command & control server in a more dynamic way.

A DGA is a program that can generate new domain names in a deterministic manner. This means that both the malware and the attacker can use the DGA to independently generate the same list of domain names. Therefore, even if an existing location for a malware's command and control server is compromised, the attacker can re-locate the command and control server to a new location (i.e. domain name) generated using the DGA in the knowledge that the malware will eventually be able to re-connect to the command and control server by searching through the domains that it independently generates using the same DGA. Of course, in some case the attacker may choose to periodically or sporadically re-locate the command and control server even in the absence of it being taken down to make the job of security researchers and law-enforcement more difficult. Typically, the DGAs used by malware comprise a time-dependent element, meaning that the list of domain names that are generated will change over time. Furthermore, in order to ensure reliable communication between the malware and the command and control server, it is common for DGAs to generate a large number of potential domain names at which the command and control server could be located. This means that the attacker has a choice of a large number of locations to deploy (or re-deploy) the command and control server to such that it is likely that at least one location will be available for the attacker's use. That is to say, it is unlikely that all (or even most) of the potential locations for the command and control server will be exhausted, either unintentionally via pre-existing domain name registrations or through the intentional actions of security researchers or law-enforcement.

Accordingly, the classifier may be trained to determine whether a domain name corresponds to a pattern of domain names that have been generated by a DGA for use by malware. That is to say, the classifier may be trained to classify domain names, whereby one or more classifications provided by the classifier indicate that a domain name was generated by a DGA used to generate domain names for malware. Although this example will continue to be discussed throughout the remainder of the description, it will be appreciated that this is just an example and the disclosure may be readily applied to other types of classifiers that may be used to protect networks.

The training that is performed by operation 210 serves to initially train a classifier which is able to perform the desired classification task to some minimal level of accuracy. This initially trained classifier then forms the starting point which will be further refined by later operations in method 200. As will be appreciated, any suitable machine learning technique may be used to train the classifier using an initial set of labelled training data (i.e. whereby each sample in the initial set of training data is associated with a correct classification that should be produced for that sample) provided that the resulting classifier has the ability to indicate a confidence in its predictions. For example, the classifier may be a Random Forest, Gradient Boosted Tree or Long-Short Term Memory Network classifier. The samples and labels in the initial training set reflect the activity and type of threat that the classifier is being trained to classify. For example, when training a classifier for identifying DGA-generated domain names used by malware, the training set may include sample domain names and a label indicating whether those domains are “legitimate” (i.e. not associated with malware) or “illegitimate” (i.e. match a pattern of domain names generated by a DGA for malware).

In any case, having initially trained the classifier to classify activity within the network as being related to a threat to the network (or not), the method 200 proceeds to an operation 220.

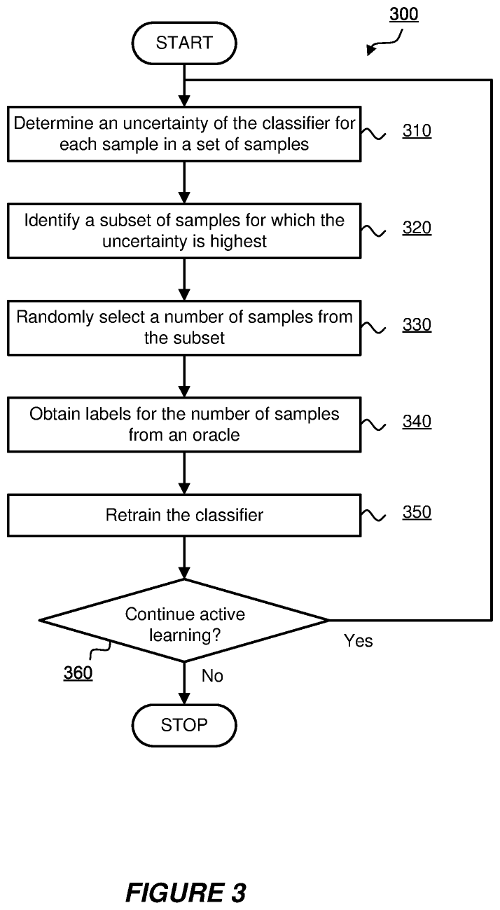

At operation 220, the method 200 retrains the classifier using an active learning technique so as to improve its accuracy. There are a number of sub-operations that are performed as part of operation 220, which collectively provide a method for retraining a classifier using active learning as used by embodiments of the disclosure. Operation 220 will now be discussed in more detail with reference to FIG. 3 which is a flowchart illustrating a method 300 for retraining a classifier using active learning that is performed by operation 220.

At an operation 310, the method 300 determines a respective level of uncertainty of the classifier in classifying each sample in a set of sample data. This sample data is a collection of sample input values for which the correct label is not currently known. The samples in the sample data are provided to the classifier to classify. The output from the classifier includes both a predicted classification for the sample and a measure of the classifier's confidence in that classification. This measure of confidence indicates the uncertainty of the classifier in its classification of that sample. The higher the measure of confidence, the lower the uncertainty and vice-versa. As an example, where the classifier is being trained to determine whether a domain name corresponds to a pattern of domain names that have been generated by a DGA for use by malware, the sample data may comprise a set of domain names. Each of the sample domain names are then provided to the classifier to obtain a predicted classification (e.g. “legitimate” or “illegitimate”) and an associated measure of the classifier's confidence in that prediction.

The sample data used by operation 310 can be obtained via any suitable technique. In some cases, the method 300 may use a static set of sample data which does not change between iterations of method 300 (other than by removing those samples which are labelled by the oracle at operation 340, as discussed in more detail below). In other cases, the sample data may be dynamic. That is to say, new samples may be added to the sample data as they become available so that the new samples are available for use with later iterations of the method 300. For example, where the classifier is being trained to determine whether a domain name corresponds to a pattern of domain names that have been generated by a DGA for use by malware, the sample domain names could be obtained by collecting domain names that have been the subject of Domain Name Service (DNS) queries within the network (although of course other techniques for obtaining the set of sample domain names could be used instead).

In any case, having determined the classifier's confidence in classifying each sample at operation 310, the method 300 proceeds to an operation 320.

At operation 320, the method 300 identifies a subset of the sample data for which the uncertainty is highest. It will be understood that the subset is a proper subset of the sample data. That is to say, the subset contains fewer samples than are contained in the sample data. The size of the subset may be predetermined, or alternatively may comprise a predetermined proportion of samples from the larger set of sample data. Selecting the subset to include those samples for which the uncertainty is highest means that the samples in the subset will have a lower (or at least equal) measure of confidence to any of the samples in the set of sample data that are not included in the subset. Conversely, the samples remaining in the set of sample data that have not been included in the subset will have a higher (or at least equal) measure of confidence to any of the samples included in the subset. Having identified the subset of samples at operation 320, the method 300 proceeds to an operation 330.

At operation 330, the method 300 randomly selects a number of samples from the subset that was identified by operation 320. The number of samples that are selected is less than the size of the subset. That is to say, some samples in the subset will not be selected by operation 330. The number of samples that are selected may be predetermined. Alternatively, the number of samples that are selected may be chosen so that the number of selected samples represents a predetermined proportion of the number of samples in the subset (i.e. the number of samples that are selected may depend on the size of the subset). The samples may be selected using any suitable random (or pseudo-random) technique. That is to say, any suitable source of randomness (or pseudo-randomness) may be used to generate random numbers that can be used to select samples from the subset, as will be familiar to those skilled in the art. Having randomly selected some of the samples from the subset, the method proceeds to an operation 340.

At operation 340, the method 300 obtains labels for the selected samples by querying (or consulting) an oracle. The oracle provides the correct label for each of the selected samples. For example, in some cases the oracle may be a security analyst who can analyze each provided sample to determine what its correct label is. However, in other cases, automated systems that are capable of carrying out this analysis may be used instead. In some cases, the oracle may comprise a combination of human and automated sources.

As an example, where the classifier is being trained to determine whether a domain name corresponds to a pattern of domain names that have been generated by a DGA for use by malware, the sample domain names that were randomly selected at operation 330 are provided to an oracle at operation 340 for labelling. The oracle then provides a label (i.e. “legitimate” or “illegitimate”) indicating whether each of the provide sample domain names are considered to have been generated by a DGA used by malware (or not). Although any suitable oracle may be used, it is noted that a technique which can automatically determine at least some labels is provided in co-pending UK Patent Application No. GB2109760.5 that was filed on Jul. 6, 2021 may be used.

Having obtained labels for the selected samples from the oracle, the method 300 proceeds to an operation 350.

At operation 350, the method 300 uses the newly labelled samples to retrain the classifier. That is to say, the samples that were labelled at operation 340 are added to a corpus of labelled training data that is used to retrain the model. In addition to the newly labelled samples, the training data may also include samples that were labelled during previous iterations of method 300 as well as the labelled samples included in the initial training data that was used to train the classifier at operation 210 of method 200. As discussed in relation to operation 210 of method 200, any suitable machine learning technique may be used to retrain the classifier at operation 350. Having retrained the classify using the newly labelled samples, the method 300 proceeds to an operation 360.

At operation 360, the method 300 determines whether active learning should continue. For example, the method 300 may be iteratively performed until the classifier reaches a certain level of accuracy when classifying a test set of data (or until a predetermined number of iterations have been performed if that accuracy is not reached). If it is determined to continue the method 300 proceeds to operation 310 to repeat operations 310-360. Otherwise, the method 300 ends and method 200 resumes by proceeding to an operation 230.

At an operation 230, the method 200 uses the trained classifier to classify activity within the network. It will be appreciated that the activity which is classified is one which the classifier is suited to classifying (i.e. a type of activity that the classifier was trained to classify). For example, where the classifier was trained to determine whether a domain name corresponds to a pattern of domain names that have been generated by a DGA for use by malware, the activity may comprise a DNS query made by a computer system in the network which identifies a domain name that the classifier can be used to classify. Accordingly, the classifier may produce a classification of either “legitimate” or “illegitimate” for the domain name that is the subject of a DNS request. Of course, it will be appreciated that there may be other activities which yield domain names which the classifier may equally be configured to classify in order to detect threats to a network. Indeed, that there are also many other features which classifiers may be trained to classify in order to detect threats to a network, as will be appreciate by the skilled person. Nonetheless, having obtained a classification of the activity, the method 200 proceeds to an operation 240.

At operation 240, the method 200 determines whether to take action to protect the network based on the classification obtained at operation 230. Where the classification indicates that the activity is a threat to the network, such as where the classification indicates that the activity is associated with malware, the method 200 triggers action to be taken to mitigate or prevent the threat from impacting the network by proceeding to operation 250. Otherwise, if the classification indicates that the activity is benign (i.e. not associated with a threat such as malware), the method 200 proceeds to an operation 260.

At operation 250, the method 200 causes action to be taken to mitigate or prevent the threat from impacting the network. It will be appreciated that the action that is taken will depend on the nature of the threat that the classifier has been trained and deployed to help detect. For example, where one or more classifications provided by the classifier indicate that the activity is associated with malware, the action that is caused to be taken is one that is intended to mitigate or prevent the activity of the malware. The selection of an appropriate action may further depend on the classification of the activity that was obtained at 230 which may indicate multiple different types of threat for which different actions may respectively be more or less appropriate.

Returning to the previously discussed example, where the classification indicates that a domain name that is the subject of a DNS request is a domain name that was generated by a DGA for use by malware (e.g. a classification of “illegitimate” is provided by the classifier for that domain name), the method 200 determines at operation 240 that action should be taken and proceeds to operation 250. At operation 250 one or more predetermined actions are then taken that are intended to mitigate or prevent the impact of that malware. For example, operation 250 may cause actions to be taken with respect to one or more computer systems in the network (such as any computer system(s) that sent DNS requests for the DGA generated domain name, which are likely to be affected by malware). This may include, for example, limiting communication from those computer systems to the rest of the network, causing a malware scan to be performed in respect of those computer systems, and/or increasing a level of monitoring that is performed in respect of those computer systems to aid investigations of the malware. Additionally or alternatively, operation 250 may also cause actions to be taken at a network level. For example, operation 250 may prevent communication with the domain name that was identified as being a DGA generated domain name for use by malware from the network, flag the domain name for review, and/or log any accesses from the network to the domain name.

Having taken action to mitigate or prevent the impact of the threat associated with the activity, the method 200 proceeds to an operation 260.

At operation 260, the method determines whether the method 200 should be repeated. That is to say, whether there are further activities to be classified. If so, the method performs a further iteration of operations 230, 240, 250 and 260 in relation to those further activities. Otherwise, the method 200 ends.

Although not illustrated in FIG. 2, the classifier may be re-trained iteratively. That is to say operation 220 may be performed periodically or sporadically to re-train the classifier whilst at the same time using the classifier in its current state to classify activities in order to protect a network. This can allow the classifier to be improved over time whenever oracle resource is available for labelling samples. It may also allow the classifier to adapt to changing patterns (such as new malware or DGAs used by malware) by including more recently obtained samples in the sample data.

As discussed above, the disclosure provides a way of training a classifier for use in protecting a network using an active learning technique. Through the random selection of samples from a subset of the samples that the classifier is most uncertain about, the samples that are sent to the oracle for labelling can generally be expected to be more diverse and therefore generally result in more information being obtained by the classifier with each iteration of active learning. This can help speed up the learning process and reduce the number of samples that an oracle is required to label in order for a classifier to reach a certain level of performance. Since labelling of samples is typically expensive (in terms of time, effort and expense), this approach can reduce the cost of training a classifier without requiring significant computational complexity to select samples.

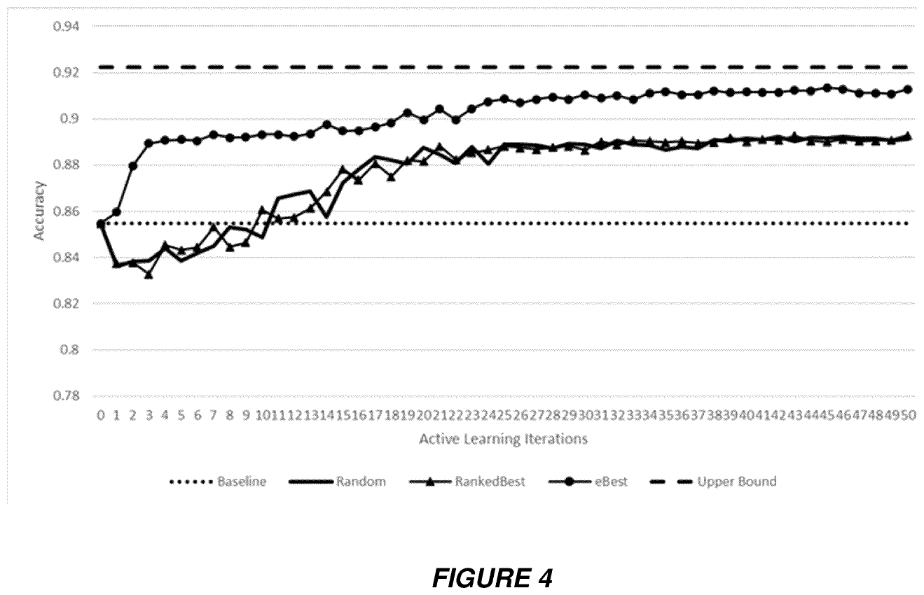

An evaluation of the performance of this random sampling approach to active learning provided by an embodiment of this disclosure has been conducted. In this evaluation, a classifier was trained to differentiate between “legitimate” and “illegitimate” domain names, whereby “illegitimate” domain names are those that conform to a pattern generated by a DGA, as discussed above. The classifier was trained using 50 iterations of the active learning approach described above with reference to FIG. 3, whereby 1000 sample domain names were selected during each iteration. For comparison, similar classifiers were trained using the same parameters (e.g. 50 iterations of active learning with 1000 sample domains being sent to the oracle for labelling at each iterations) according to two other active learning approaches. The first of those comparisons is made with the “RankedBest” active learning approach which selects those samples at each iteration about which the classifier was most uncertain. The second comparison is made with a random sampling active learning approach which selects a subset if samples at random (without any regard for the classifier's certainty regarding its predictions about those samples). FIG. 4 is a chart showing the results of this evaluation with the accuracy of the resulting classifier plotted after each iteration of learning using each of the active learning techniques. On the chart, the performance provided by the present disclosure is shown by the data series labelled “eBest” (shown using solid black circles). As can be seen, the results provided by embodiments of the disclosure exceeds that of the other approaches. That is to say, the classifier trained using the actively learning approach of the disclosure yields a higher accuracy classifier after each iteration of active learning. Meanwhile the performance of the other two approaches is approximately the same.

Insofar as embodiments of the disclosure described are implementable, at least in part, using a software-controlled programmable processing device, such as a microprocessor, digital signal processor or other processing device, data processing apparatus or system, it will be appreciated that a computer program for configuring a programmable device, apparatus or system to implement the foregoing described methods is envisaged as an aspect of the present disclosure. The computer program may be embodied as source code or undergo compilation for implementation on a processing device, apparatus or system or may be embodied as object code, for example. Suitably, the computer program is stored on a carrier medium in machine or device readable form, for example in solid-state memory, magnetic memory such as disk or tape, optically or magneto-optically readable memory such as compact disk or digital versatile disk etc., and the processing device utilizes the program or a part thereof to configure it for operation. The computer program may be supplied from a remote source embodied in a communications medium such as an electronic signal, radio frequency carrier wave or optical carrier wave. Such carrier media are also envisaged as aspects of the present disclosure.

It will be understood by those skilled in the art that, although the present disclosure has been described in relation to the above described example embodiments, the disclosure is not limited thereto and that there are many possible variations and modifications which fall within the scope of the disclosure. The scope of the present disclosure includes any novel features or combination of features disclosed herein. The applicant hereby gives notice that new claims may be formulated to such features or combination of features during prosecution of this application or of any such further applications derived therefrom. In particular, with reference to the appended claims, features from dependent claims may be combined with those of the independent claims and features from respective independent claims may be combined in any appropriate manner and not merely in the specific combinations enumerated in the claims.

1. A computer implemented method for protecting a network, the method comprising:
training a classifier to classify activity within the network;
retraining the classifier using an active learning technique by:
determining a respective level of uncertainty of the classifier in classifying each sample in a set of sample data,
identifying a subset of the sample data, the subset comprising a plurality of samples from the set of sample data for which the respective level of uncertainty is highest,
randomly selecting a number of samples from the subset of the sample data, wherein the number of samples is less than a size of the subset of the sample data,
labelling samples in the selected number of samples by querying an oracle, and
using training data comprising the labelled samples to retrain the classifier;
using the retrained classifier to classify activity within the network; and
determining whether to take action to protect the network based on the classification of the activity by the retrained classifier.

2. The method of claim 1, wherein the number of samples that is selected from the subset is a predetermined number.

3. The method of claim 1, wherein the number of samples that is selected from the subset is a predetermined proportion of the subset of the sample data.

4. The method of claim 1, further comprising causing action to be taken to mitigate or prevent the activity from impacting the network in response to determining that action should be taken to protect the network.

5. The method of claim 4, wherein one or more classifications provided by the classifier indicate that the activity is associated with malware and the action comprises one or more predetermined actions for mitigating or preventing the activity of the malware, the action being taken in response to a classification indicating that the activity is associated with malware.

6. The method of claim 5, wherein:
the classifier is trained to classify domain names, whereby one or more classifications provided by the classifier indicating that a domain name was generated by a Domain Generation Algorithm (DGA) used to generate domain names for malware;
the activity comprises a DNS query made by a computer system in the network; and
the one or more predetermined actions are taken in response to a classification of a domain name that is a subject of the DNS query indicating that the domain name was generated by a DGA used to generate domain names for malware.

7. The method of claim 6, wherein the one or more predetermined actions comprise one or more, or all, of:
causing a malware scan to be performed in respect of the computer system;
increasing a level of monitoring that is performed in respect of the computer system;
preventing communication with the domain name;
flagging the domain name for review; and
logging the access to the domain name.

8. A computer system comprising a processor and a memory storing computer program code for performing the method of claim 1.

9. A non-transitory computer-readable storage medium storing a computer program which, when executed by one or more processors, is arranged to carry out the method according to claim 1.
